(19) United States
(12) Patent Application Publication
(10) Pub. No.: US 2013/0291436 A1
(43) Pub. Date: Nov. 7, 2013

(54) STACKABLE PLANT POT ASSEMBLY

(71) Applicants: Susan Stockman, Coral Springs, FL (US); Ronald Stockman, Coral Springs, FL (US)

(72) Inventors: Susan Stockman, Coral Springs, FL (US); Ronald Stockman, Coral Springs, FL (US)

(21) Appl. No.: 13/462,981

(22) Filed: May 3, 2012

(51) Int. Cl. A01G 9/02; A01G 27/04

(52) U.S. Cl. 47/81; 47/65.5; 47/86

(57) ABSTRACT

A stackable plant pot assembly having a planter base that has a bottom surface, an upper edge defining a base opening, and a downwardly tapered side wall separating the upper base edge and the body surface. The assembly further has a first intermediate planter with an upper edge defining an upper opening, a lower edge defining a lower opening, a downwardly tapered side wall separating the upper edge and the lower edge, with the intermediate planter being both sized to removably couple to the planter base and create a substantially watertight seal and sized to stackably-receive the planter base within the upper opening of the first intermediate planter. The assembly further has a cover that is removably-couplable to the planter base and the first intermediate planter with the cover defining at least one opening sized to receive a standard-sized plant pot.

### FIELD OF THE INVENTION

The present invention relates generally to an assembly for potting plants, and more particularly relates to a collapsible and stackable plant pot assembly that supports and maintains any number of plants.

### BACKGROUND OF THE INVENTION

The need/desire for continued plant growth, which generally includes flowers, herbs, shrubs, trees, and vegetables, is very well known. As the population of the earth increases so does the need to support the growing population. It is a well-known fact that plants facilitate the production of oxygen and they convert expelled atmospheric carbon dioxide into sugar used in the photosynthesis process. Besides that necessary by-product, plants also provide food, bio-fuel, a source of therapeutic and pharmaceutical remedies, beauty to the environment, and many other scientific, cultural, and aesthetic purposes. As such, human cultivation of plants is an important ingredient of agriculture that supports the growing population and human civilization in general. Much of the agriculture is done commercially or occurs naturally, but there still remains a contingency of the population that independently grows and maintains plants. Many people grow plants, at least in part, because of the convenience, plant availability, quality—i.e. no additives and/or preservatives, low cost, and simply for enjoyment.

Generally, there are two basic ways to grow plants, which include doing so in traditional surface-bound soil/dirt or hydroponics. Hydroponics is the growing of plants in a way that does not depend on utilization of traditional surface-soil placement. Many people who plant have turned to hydroponics because of the space savings that is generally needed to grow plants in soil/dirt within the ground. Hydroponics, however, requires constant monitoring and specific attention to the nutrient mixture used to supply the plant, or else the growth may be hindered or stop entirely.

To save space and continue utilizing soil/dirt, it is well-known that plant pot apparatuses are available. Generally, plant pots are easily transportable and can be placed virtually in any location where sunlight and water is available. One significant problem with typical plant pots is the space they continue to take up while in use and, more particularly, when not in use such that they require storing. This is specifically applicable for many users who can only grow plants during certain seasons of the year because of the outside temperature or weather conditions. As a result, many users are currently forced to either throw the pots away or inconveniently store them by stacking them on themselves, as shown in FIG. 1. This, of course, assumes that the plant pots utilized are of the same shapes. Otherwise, a user would be required store the pots by stacking pots of different configurations on top of each other, which is extremely inefficient with space and potentially unsafe. Furthermore, most known plant pots are filled with dirt or fertilizer that encapsulate and support the plants growing inside the pot. These plant pots do not efficiently maximize the space inside the pot as there is excess dirt that is generally of no benefit to the plant. As such, when dirt or fertilizer are added to larger-sized pots the weight of the pot makes it difficult to move around, which is also problematic for many users.

Some known plant pot assemblies that are designed to hold various sized plants require stacking multiple modular plant pots on top of each other in different configurations. As it implies, these assemblies still require multiple plant pots, instead of utilizing a singular plant pot to hold various sized plants. It is because of the fact that these pots are modular in nature, that they are unable to create a watertight seal to store large amounts of water. Second, as many of these assemblies utilize multiple individual pots stacked on each other in different configurations, they generally require a base or other structure that holds the water at the bottom of the assembly. This creates the inconvenient task of accessing and cleaning the base, which is generally located at the bottom of the assembly, and further provides another component that requires storing. Moreover, for those known assemblies that do have a water reservoir, it is generally limited in size such that a user is still required to continually refill the reservoir.

Furthermore, as most known assemblies or systems of holding and maintaining plants are not stackable and require multiple individual pots, the user is limited to the size of those individual pots. Therefore, a user is prevented from having an assembly that is adaptable to supplying water to various sized plant pots. As the assemblies also require multiple modular pots stacked in various configurations, they also are not easily transported themselves. Few, if any, plant pot assemblies allow a user to have a uniform, easy transportable, adjustable, and readily-storable assembly that can hold and maintain multiple plant pots of various sizes.

Therefore, a need exists to overcome the problems with the prior art as discussed above.

### SUMMARY OF THE INVENTION

The invention provides a stackable plant pot assembly that overcomes the hereinafore-mentioned disadvantages of the heretofore-known devices and methods of this general type and that provides a plant pot holder, featuring stackable members, capable of receiving plants of various heights and sizes, and is unstackable to provide quick, easy, and efficient storage. The invention further provides a plant pot assembly that is operable to self-water those plants being supported with a common large water reservoir.

With the foregoing and other objects in view, there is provided, in accordance with the invention, a stackable plant pot assembly that has a planter base with a bottom surface, an upper base edge that defines a base opening, and a downwardly tapered side wall separating the upper base edge and the bottom surface, with the assembly also having a first intermediate planter that has a an upper edge defining an upper opening, a lower edge defining a lower opening, a downwardly tapered side wall separating the upper edge and the lower edge, and is both sized to removably couple to the planter base and create a substantially watertight seal and sized to stackably-receive the planter base within the upper opening of the first intermediate planter. The assembly also includes a cover removably-couplable to the planter base and the first intermediate planter, with the cover defining at least one opening sized to receive a standard-sized plant pot.

In accordance with another feature, an embodiment of the present invention includes a wick that extends substantially from the standard-sized plant pot toward the bottom surface of the planter base.

In accordance a feature of the present invention, the upper opening of the first intermediate planter is sized to stackably-receive the planter base substantially within upper opening.

In accordance with yet another feature, an embodiment of the present invention includes a second intermediate planter that has an upper edge defining an upper opening, a lower edge defining a lower opening, a downwardly tapered side wall separating the upper edge and the lower edge, and is sized to be removably-couplable to the first intermediate planter and create a substantially watertight seal and is sized to stackably-receive the planter base and the first intermediate planter within the second intermediate planter upper opening, and wherein the cover is removably-couplable to the planter base and the first and second intermediate planters.

In accordance with a further feature of the present invention, the second intermediate planter is further sized to be removably-coupable to the first intermediate planter and the planter base to create a substantially watertight seal.

In accordance with another feature of the present invention, the upper opening of the second intermediate planter is sized to stackably-receive the planter base and the first intermediate planter substantially within upper opening.

In accordance with yet another feature of the present invention, the cover is removably-couplable to an inside surface of the side wall of the planter base and the first intermediate planter.

In accordance with a further feature, one embodiment of the present invention includes the cover having a rubber seal located on an outer surface of the cover, wherein a portion of the rubber seal is removably-couplable to an inside surface of the side wall of the planter base and the first intermediate planter.

In accordance with a further feature, an additional embodiment of the present invention the cover includes a plurality of openings sized to receive a standard-sized plant pot.

In accordance with the present invention, a stackable plant pot assembly may also have a planter base that has a bottom surface, an upper base edge that defines a base opening, and a downwardly tapered side wall separating the upper base edge and bottom surface, a plurality of intermediate planters each of the intermediate planters having an upper edge defining an upper opening, a lower support edge defining a lower opening, a downwardly tapered side wall separating the upper edge and the lower edge, being sized to removably couple to at least one of the planter base and one of the plurality of intermediate planters to create a substantially watertight seal, and one of the planters that has at least one upper opening being sized to stackably-receive the planter base and the plurality of intermediate planters within the at least one upper opening, the assembly also including a cover removably-couplable to the planter base and the plurality of intermediate planters, the cover defining at least one opening sized to receive a standard-sized plant pot.

In an additional feature of the present invention, the at least one upper opening is sized to stackably-receive the planter base and the plurality of intermediate planters substantially within the at least one upper opening.

In accordance with a further feature of the present invention, the cover is removably-couplable to an inside surface of the side wall of the planter base and the plurality of intermediate planters.

In accordance with a further feature, one embodiment of the present invention the cover having a rubber seal located on an outer surface of the cover, wherein a portion of the rubber seal is removably-couplable to an inside surface of the side wall of the planter base and the plurality of intermediate planters.

In accordance with an additional feature, one embodiment of the present includes a wick that extends substantially from the at least one opening in the cover toward the bottom surface of the planter base.

In accordance with the present invention a stackable plant pot assembly includes a plurality of planter members with one of the plurality of planter members that has a bottom surface, an upper base edge defining an upper base opening, and a downwardly tapered side wall separating the upper base edge and the bottom surface, the plurality of planter members with at least one of the plurality of planter members having an upper edge defining an upper opening, a lower edge defining a lower opening, and a downwardly tapered side wall separating the upper edge and the lower edge and having an inner surface that defines an inner volume. The plurality of planter members each being sized to removably couple to at least one of the plurality of planter members to form a substantially watertight seal and are removably-stackable at least partially within the inner volume of at least one of the plurality of planter member, with the assembly also a cover removably-couplable to at least one of the plurality of planter members.

In accordance with a further feature of the present invention, the plurality of planter members are removably-stackable substantially within the inner volume of at least one of the plurality of planter members.

In accordance with yet another feature of the present invention, the cover is removably-couplable to an inside surface of the side wall of the plurality of planter members.

Although the invention is illustrated and described herein as embodied in a stackable plant pot assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to a general direction of the plant pot assembly from the bottom surface toward the upper edge.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective downward-looking cross-sectional view of multiple prior-art plant pots of the same configuration stacked within the openings of one-another;

FIG. 2 is a perspective downward-looking cross-sectional view of a stackable plant pot assembly including a base planter, a first intermediate planter, and a cover in accordance with the present invention;

FIG. 3 is an exploded view of the plant pot assembly of FIG. 2 showing a water reservoir within the base planter in accordance with one embodiment of the present invention;

FIG. 4 is a perspective downward-looking cross-sectional view of the plant pot assembly of FIG. 2 with a plant pot having a wick extending downwardly into a reservoir of water in accordance with an embodiment of the present invention;

FIG. 5 is a perspective downward-looking cross-sectional view of the plant pot assembly of FIG. 2 with the base planter and cover stacked within an upper opening of the first intermediate planter in accordance with an exemplary embodiment of the present invention;

FIG. 6 is an exploded view of the stackable plant pot assembly additionally including a second intermediate planter in accordance with another exemplary embodiment of the present invention;

FIG. 7 is a fragmentary perspective downward-looking view of the plant pot assembly of FIG. 6 with all planter members stacked within one-another in accordance with one embodiment of the present invention;

FIG. 8 is a fragmentary perspective downward-looking view of the plant pot assembly with all planter members stacked on top of one-another in accordance with one embodiment of the present invention;

FIG. 9 is a fragmentary elevational cross-sectional view of the assembly of FIG. 8 with portions of the base planter being shape to removably couple with the first intermediate planter to create a watertight seal in accordance an embodiment of the present invention;

FIG. 10 is a perspective downward-looking cross-sectional view of the plant pot assembly of FIG. 6 with the base planter, first intermediate planter, and cover stacked within an upper opening of the second intermediate planter in accordance with an exemplary embodiment of the present invention;

FIG. 11 is a top plan view of the cover with a plurality of openings and a rubber seal located on an outer surface of the cover in accordance with another embodiment of the present invention;

FIG. 12 is a top plan view of the cover with a spring assembly inserted within at least one portion of the cover in accordance with yet another embodiment of the present invention;

FIG. 13 is an elevational cross-sectional view of the cover having a side wall extending upwardly from one or more portions of a top surface of the cover in accordance with one embodiment of the present invention;

FIG. 14 is a top plan view of a cover from a plant pot watering assembly in accordance with an exemplary alternative embodiment of the present invention; and

FIG. 15 is an elevational side view of the assembly of FIG. 14 with plant pots within openings on the cover and a base defining a reservoir fillable with water in accordance with an embodiment of the present invention.

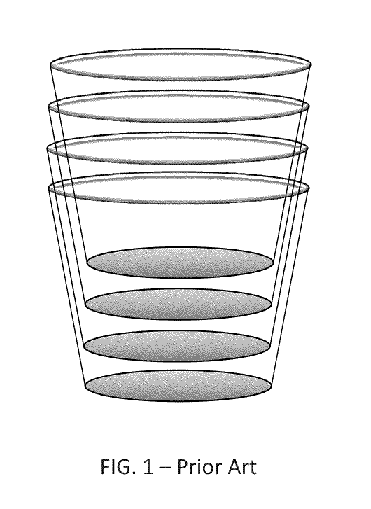

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient plant pot assembly 200 that features one or more stackable, i.e., nested, planter members 204 being capable of storing and supporting one to multiple plants when in use, yet being unstackable to a convenient and efficient size when not in use. Embodiments of the invention provide an assembly that creates a watertight seal in order to maintain a water reservoir that is capable of providing water to those plants being stored without constant supervision or monitoring.

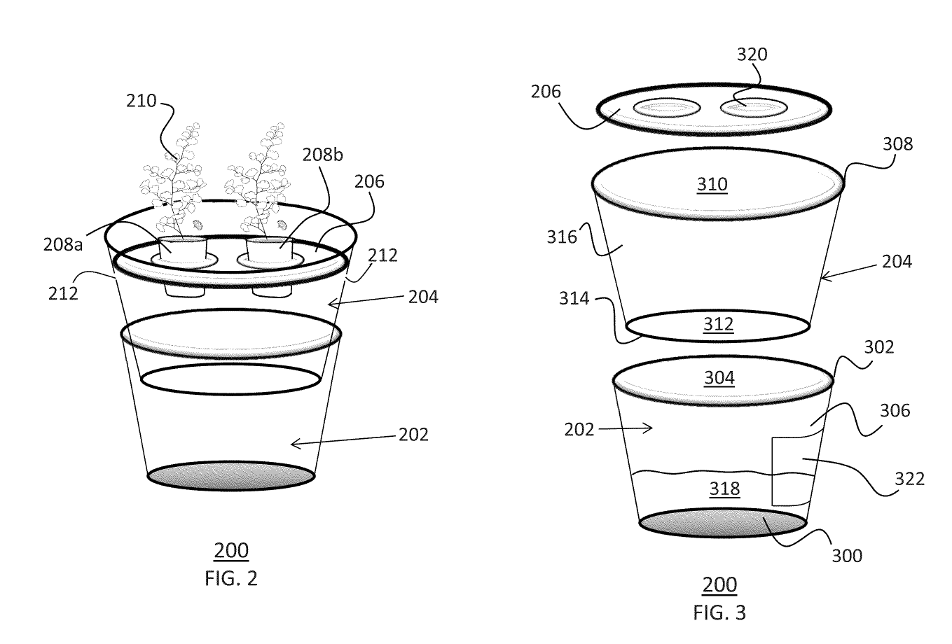

Referring now to FIG. 2, one embodiment of the present invention is shown in a perspective downward-looking cross-sectional view. FIG. 2 shows several advantageous features of the present invention, but, as will be described below, the invention can be provided in several shapes, sizes, combinations of features and components, and varying numbers and functions of the components. The first example of a stackable plant pot assembly 200, as shown in FIG. 2, includes a planter base 202, a first intermediate planter 204, and a cover 206. The assembly 200 is shown with the first intermediate planter 204 stacked at least partially within the planter base 202 in accordance with one embodiment of the present invention. The cover 206 is shown supporting two plant pots 208a-b, each having a plant 210 inserted within, in accordance with one embodiment of the present invention.

In one embodiment, the planter base 202, intermediate planter 204, and cover 206 are made from a durable water-resistant polymer with a hardness ranging from approximately 60-90 shore A. In other embodiments, the aforementioned components are made from harder or softer polymers, composites, metallics, or a combination of any of the above materials which have the general material properties of being water resistant and yield strength sufficient to support the weight of any of the planter members which are coupled thereto. The aforementioned components may also have portions that have a flexible rubber-like material that allow one or more components to more effectively seal with one-another. The above components may also be transparent to allow a user to view the contents therein, or the water level.

FIG. 3 illustrates the assembly 200 in an exploded view. The planter base 202 has a bottom surface 300, an upper base edge 302 that defines a base opening 304, and a downwardly tapered side wall 306 that separates the upper base edge 302. Similarly, the first intermediate planter 204 also has an upper edge 308 that defines an upper opening 310. The first intermediate planter, however, can also be seen having a lower opening 312 that is defined by a lower edge 314 and a downwardly tapered side wall 316 that separates the upper edge 308 and the lower edge 314. As described, the planters 202, 204 (also referred to herein as “planter members”) are sized to removably couple to each other to create a watertight seal. The term “substantially watertight seal” is defined as two or more objects or surfaces that are coupled together which resists liquid, e.g. water, from exiting into an outside environment opposite to the liquid inside.

When the assembly 200 is desired to be used, the user couples the planters 202, 204 together as shown in FIG. 2 and fills the assembly 200 with water. When filled, the assembly 200 can be seen having a water reservoir 318 located within. Although the reservoir 318 is shown filled just below half capacity of the base planter 202, because the assembly 200 is substantially watertight, the water reservoir 318 may extend into the first intermediate planter 204. This allows the assembly 200 to hold a larger amount of water than those known plant pots and advantageously water multiple plants at the same time. Referring briefly back to FIG. 2, in one embodiment, one or more apertures 212 are defined by the intermediate planter 204 adjacent the upper edge 308 of the planter 204. Should the water level of the reservoir 318 rise up to meet the apertures 212, the water will be released from the reservoir 318 to prevent the water from pushing up on the plant pots 208a-b. In other embodiments, the apertures may be located closer or on the upper edge 308. Furthermore, should more than one planter 204 be utilized, the apertures 212 may be plugged with one or more plastic inserts to prevent water from being released. If both planters 202, 204 are utilized, then the cover 206 would be inserted therein. In one embodiment, the cover 206 is removably-couplable to either the planter base 202 or the intermediate planter 204. With the cover being removably-couplable to either planter 202, 204, a user can choose which of the planter members 202, 204 should be used to either increase or decrease the height of the assembly 200 in order to accommodate differently sized plant pots. The cover 206 also defines at least one opening 320 sized to receive a standard-sized plant pot. A standard-sized plant pot generally ranges from the maximum diameter of about 2 inches to 10 inches. This range may be in increased or decreased, however, depending on the various sized covers 206 and its corresponding opening(s) 320.

As shown in FIGS. 2 and 3, the cover 206 is sized to be removably-couplable to both of the planters 202, 204. When the cover 206 sits within the assembly, as shown in FIG. 2, one or more standard-sized plant pots 208a-b are inserted within the opening 320. In other embodiments, the cover 206 may have a plurality of openings 320 shaped to receive a plurality of different sized plant pots of different configurations. When a plant pot 208a is inserted into the opening 320 a portion of the pot 208a may be at least partially submerged within the reservoir 318. In one embodiment, the user would fill the reservoir up until the point where the cover 206 is coupled one or more of the planters 202, 204. In other embodiments, the user may fill to a desired point along the side walls 306, 316. As such, the bottom surface 300 and side walls 306, 316 should be substantially free of openings in order to also prevent water from escaping. In further embodiments, should the planters 202, 204 not be made with a transparent or translucent material, one or more of the planters 202, 204 may have a window 322 to monitor the reservoir level 318, as shown in FIG. 3. The window 322 may also have one or more indicators to reflect when the water level is high or low

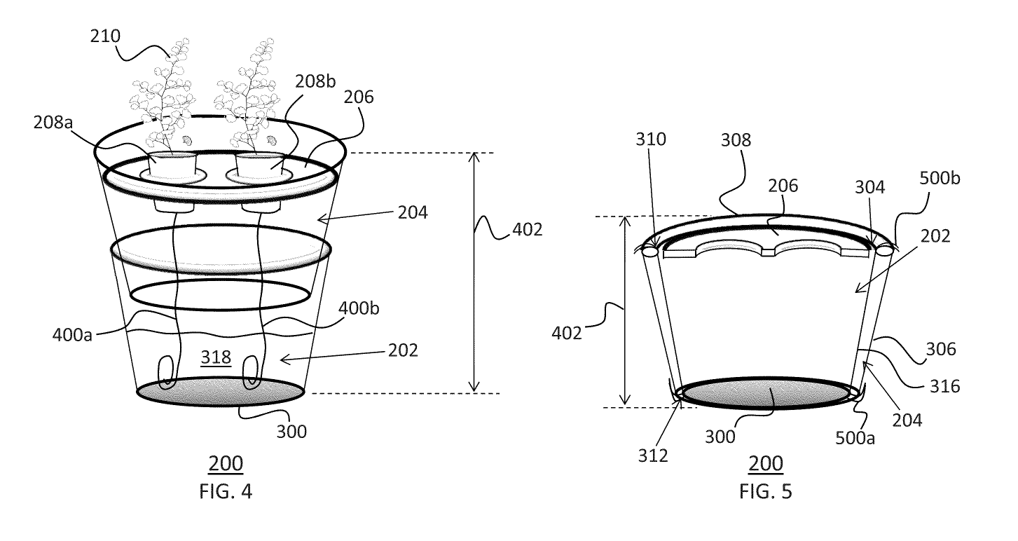

Referring now to FIG. 4, the assembly 200 is again shown with two standard-sized plant pots 208a-b inserted within the opening 320 of the cover 206. As described, the plant pot 208a may be at least partially submerged in the reservoir 318. In other embodiments, however, the assembly 200 has one or more wicks 400a-b extending substantially from the standard-sized plant pots 208a-b toward the bottom surface 300. Although there are two wicks 400a-b shown, the amount of wicks 400a-b may vary depending on the amount of pots 208a-b utilized. Further, a pot 208a with a length sufficient to reach the reservoir 318 may not have a wick 400a. The wicks 400a-b provide water from the reservoir 318 to each plant 210 within the pot 208a-b. As the underlying principle of capillary action associated with “wicking” is generally known in the art, a detailed discussion is not needed.

When applied to the present invention, however, the user can now advantageously insert plant plots 208a-b of various sizes and configurations into the at least one opening 320 in the cover 206 and utilize the wick 400a-b to water each plant 210. Further, multiple plants that require different amounts of water can now be placed within the same pot. For example, an autumn fern, which generally is needed to be continually watered, and a desert cactus, which does not, may both be grown in the same pot. For those plant pots 208a-b not submerged within the reservoir 318, the wicks 400a-b would simply extend from those pots 208a-b to the reservoir 318. Generally, standard-sized plant pots 208a-b have an opening at the bottom wherein the wicks 400a-b would extend from that opening. In other embodiments, the wicks 400a-b may extend from a top portion of the pots 208a-b toward the bottom surface 300. As such, the user is provided with an assembly 200 that conveniently waters itself from a single water source.

The wicks 400a-b may be made into various lengths to accommodate small or large pots 208a-b and the distance from those pots 208a-b to the bottom surface 300. In one embodiment, the wicks 400a-b are Venetian-blind-type cord that has a diameter of approximately ¼ inch and extends approximately 18 inches long. In other embodiments, the wicks 400a-b may be a cotton fabric or other materials that support capillary action and may be less than or greater than ¼ inch and 18 inches in diameter and length, respectively, but should be sized to accommodate the maximum length of an assembly height 402. The assembly height 402 is adjustable, in accordance with the present invention, depending on the amount of planter members 202, 204 utilized.

Now referring to FIG. 5, the assembly is shown in a perspective downward-looking cross-sectional view. To effectively store the assembly 200 when not being utilized, the intermediate planter 204 is shown sized to stackably-receive the planter base 202 within the upper opening 310 of the first intermediate planter 204. In one embodiment, both planters 202, 204 have side walls 306, 316 that are downwardly tapered and have a slightly larger upper openings 304, 310 than one-another. In other embodiments, the upper openings 304, 310 may vary with both the lower opening 312 and bottom surface 300 not varying in length and width. This advantageously allows a single potting assembly to hold and support pots of various sizes and capable of being broken down into a structure that is compact and easily storable. It can also be readily appreciated that the height 402 (shown in FIG. 4) has almost reduced by approximately 50%. This allows a user to store the assembly 200 in small portions of the garage, attic, basement, cabinets, or other areas not previously achieved with the prior-art plant pot assemblies.

In one embodiment, the bottom surface 300 and the lower opening 312 are substantially the same size such that when the planter base 202 is inserted within the opening 310 of the intermediate planter 204, the base 202 has one or more portions that protrude over the upper edge 308 of the intermediate planter 204. In other embodiments, the lower opening 312 (shown in FIG. 2) is slightly larger than the bottom surface 300 of the planter base 202, such that the upper opening 310 of the intermediate planter 204 is sized to stackably-receive the planter base 202 substantially within the upper opening 310. Said another way, when planter base 202 is “substantially within,” the planter base 202 can be said to have approximately more than 50% of the height of the base 202 within the opening 310 of the intermediate planter 204. As such in FIG. 5, the planter base 202 is completely within the opening 310 of the intermediate planter 204. When the base 202 is substantially within, or recessed, within the opening 310 of the intermediate planter 204, the assembly 200 is assured maximum storing efficiency.

In further embodiments, the base planter 202 has one or more portions 500a-b at the bottom and at the top that extend outwardly to fasten or retain the intermediate planter 204 when inserted within to allow the assembly to be carried and transported as one piece.

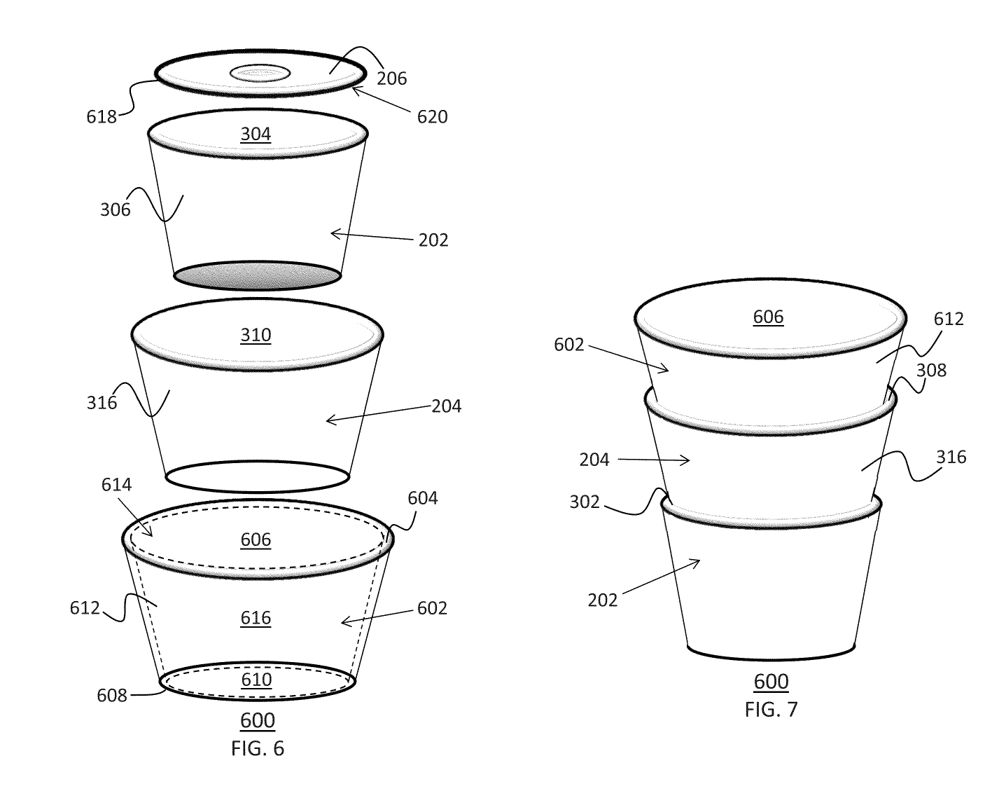

Referring now to FIG. 6, one embodiment of the present invention is shown in an exploded cross-sectional view. The assembly 600 is shown including a second intermediate planter 602 (also referred to as a “planter member”). Similar to the first intermediate planter 204, the second intermediate planter 602 includes an upper edge 604 defining an upper opening 606, a lower edge 608 defining a lower opening 610, and a downwardly-tapered tapered side wall 612 that separates the upper edge 604 and the lower edge 608. The second intermediate planter 602, however, includes a larger upper opening 606 than the opening 310 of the first intermediate planter 204. As such, the assembly 600 is able to accommodate pots 400 of various lengths and sizes. In other embodiments, the assembly 600 would be said to have a plurality of intermediate planters, e.g. the first and second intermediate planters 204, 602, that allow the user to use multiple planters, each being interchangeable with the other to create a desired assembly height 402 (shown in FIG. 4). The user may change the width or height of the assembly with the various sized planter members, such as the first and second intermediate planters 204, 602.

FIG. 7 illustrates the assembly 600 being stackable in accordance with one embodiment of the present invention. Also, similar to the first intermediate planter 204, the second intermediate planter 602 is sized to be removably-couplable to another part of the assembly, in this case, the first intermediate planter 204. The coupling between the planters creates a substantially watertight seal. In other embodiments, the second planter 602 is further sized to be removably-couplable to either, or both, of the first planter 204 and the base planter 202 to create a substantially watertight seal. This further provides the user with various configurations and stacking options. In addition to the adjustable height, the assembly 600 further provides the user easy and efficient access to the water supply by removing one or more of the planter members 204, 602. The quick and easy access allows the user to effectively and efficiently replenish or monitor the reservoir 318 level (shown in FIG. 3).

In one embodiment, the intermediate planter members 204, 602 removably couple to each other and/or the planter base 202 by forming a watertight seal with upper edges 302, 308 of the base 202 and first intermediate planter 204, respectively, and one or more portions of the side walls 316, 612. To facilitate the coupling, the upper edges 302, 308 have a gasket that is activated when the intermediate planters 204, 602 are pushed within upper openings 304, 310 (shown in FIG. 6) of the base 202 and first intermediate planter 204, respectively. The gasket may be made from various forms of rubber, closed-cell foams, or similar material that is elastically deformable when subjected to pressure and substantially impermeable to liquid, such as water. When activated, the gasket should be sufficient to resist the water pressure when the reservoir 318 (shown in FIG. 3) level is above the base planter 202. In other embodiments, the side walls 316, 612 have a sealing gasket located on one or more portions to create the watertight seal.

In other embodiments, one or more of the planters 202, 204, 602 have a female-track portion that is shaped to receive a male-track portion on one or more planters 202, 204, 602. The male and/or female track portion may also have a material located therein that also serves as a gasket. When desired to be used, the male-track portion has a part thereof that fits within a section of the female-track portion. As the user twists one of the planters 202, 204, 602, the male-track portion locks into place, assuring a watertight seal. The planters 202, 204, 604 may also couple together using threaded connectors or other similar structural mating connections.

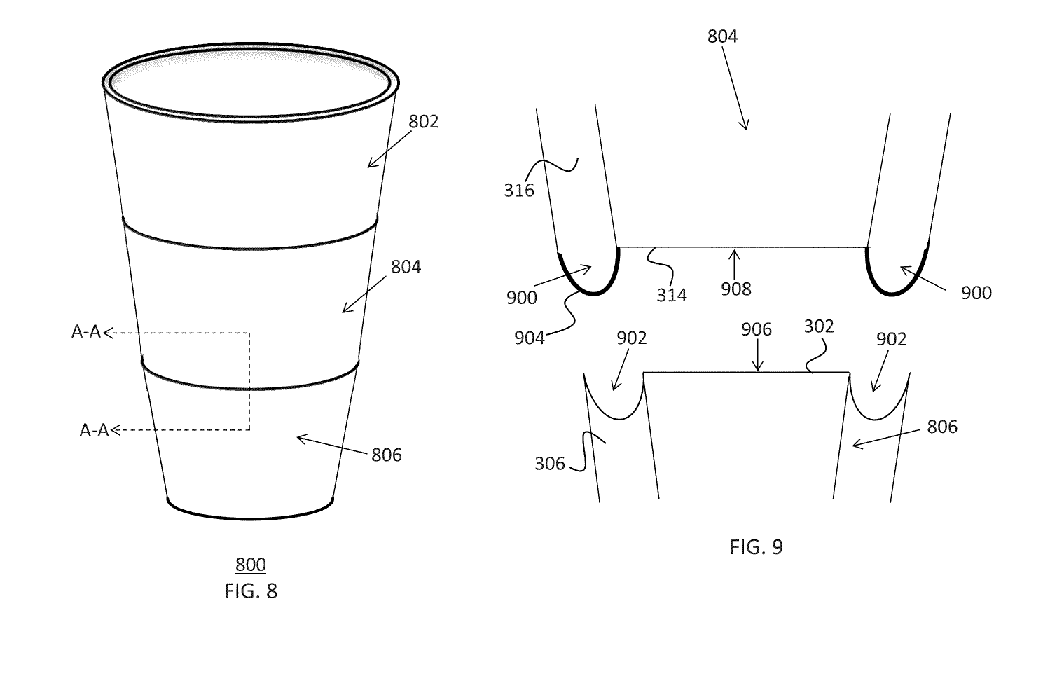

Referring now to both FIGS. 8 and 9. FIG. 8 illustrates the assembly 800 with the second intermediate planter 802 removably coupled to the first intermediate planter 804 and the first intermediate planter 804 removably coupled to the planter base 806 incorporating another male-female coupling method in accordance with an additional embodiment of the present invention. The planter members 802, 804, 806 are coupled together in a way that creates a substantially watertight seal. FIG. 9 illustrates a fragmentary elevational cross-section A-A (shown with hash marks in FIG. 8) of the assembly 800. Specifically, the first intermediate planter 804 is shown having a portion 900 protruding away from the lower edge 314. This portion 900 is shaped to engage with a female recessed portion 902 of the base planter 806 to create a watertight seal.

In one embodiment, the male and female portions 900, 902 extend continually around the lower edge 314 and upper edge 302, respectively, to ensure a watertight seal. In other embodiments, should the male-female portions 900, 902 be substantially aligned, the portions 900, 902 may be in one or more locations along the upper edge 302 and lower edge 314. The male portion 900 may further have a rubber-type coating 904 surrounding the male portion to facilitate the sealing process. The female-portion 902 may also have the same type of coating within the recessed area of portion 902. As described, the upper opening 906 of the base planter 806 and the lower opening 908 of the first intermediate planter 804 would be substantially the same size, but may vary depending on the side wall 306, 316 thicknesses. Regardless of the coupling method, one of the planter members 802, 804, 806 is sized to also stackable-receive the other planter members 802, 804, 806. Generally, however, the planter member capable of storing the other planter members 802, 804, 806 will be the planter member with the largest upper opening, regardless of how many planter members are utilized.

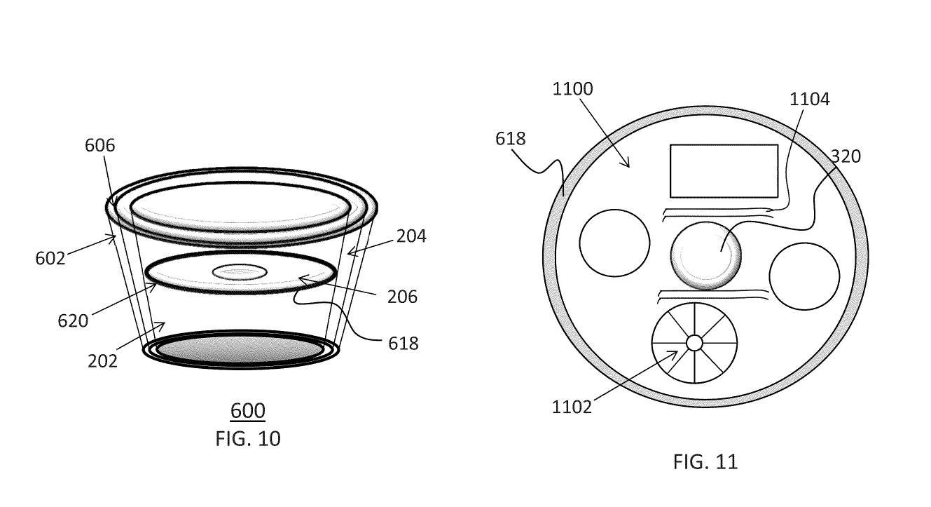

Referring now to FIG. 10, in combination with FIG. 6, FIG. 10 shows the assembly 600 in a perspective downwardly-looking cross-sectional view. FIG. 10 specifically illustrates the assembly 600, as shown in FIGS. 6 and 7, with the second intermediate planter 602 being sized to stackably-receive the planter base 202 and the first intermediate planter 204 within the second intermediate planter opening 606. In further embodiments, the base planter 202 and first intermediate planter 204 are substantially, as opposed to completely, within the upper opening 606 of the intermediate planter 602, making the assembly 600 easily storable. It can thus be readily appreciated how the assembly 600, when all planter members are utilized, as shown in FIG. 7, can be quickly and efficiently reassembled, with a resulting reduction in height of approximately 50%. In other embodiments, to assist the user in properly stacking the planter members 202, 204, 602 in the correct order, should all members 202, 204, 602 be used, an image may be sketched or drawn on an outer surface of the side walls 306, 316, 612. When the user removes the planter members 202, 204, 602 from the stored position and assembles them, the combination of the planters 202, 204, 602 would form the image.

One of the plurality of planter members 202, 204, 602 (exemplified in FIG. 6 by the second intermediate planter member 602) has an inner surface 614 that defines an inner volume 616 (outlined with a hash line). As previously described, the plurality of planter members—e.g. the base planter 202, first intermediate planter 204, and second intermediate planter 602—are removably-stackable at least partially within the inner volume 616 of at least one of the plurality of planter members 202, 204, 602. Generally, one of the upper openings 304, 310, 606 having the largest diameter is the planter member sized to receive the remaining planter members 202, 204, 602. One of the plurality of planter members 202, 204, 602 is generally going to have all of the other planter members at least partially, or substantially, within the volume 616. In other embodiments, the plurality of planter members 202, 204, 602 are removably-stackable substantially within the inner volume 616 of at least one of the plurality of planter members.

Still referring to FIGS. 6 and 10, in one embodiment the cover 206 is removably-couplable to the inside surface of the side walls 306, 316 of the planter base 202 and the first intermediate planter 204, respectively. In other embodiments, the cover 206 may be removably-couplable also to the inner surface 614 of the second intermediate planter 602 side wall 612. This advantageously gives the user the option to interchange one singular cover 206 with each one of the planter members 202, 204, 602. Furthermore, as the cover 206 is not required to make a watertight seal with any one of the planter members 202, 204, 602 which support it, the cover 206 may have two or more portions that make contact with the inner surfaces of the side walls 306, 316, 612. In another embodiment, the cover 206 as has a rubber seal 618 located on its outer surface 620, such that one or more portions of the rubber seal 618 is coupled to one or more of the plurality of planter members 202, 204, 602.

Now referring to FIG. 11, a top plan view of the cover 1100 is shown. Although the cover 1100 has been shown as having one opening 320, the cover 1100 may have more than one opening 320, as shown. In other embodiments, the cover 1100 has a plurality of openings sized to receive multiple plant pots. With the cover 1100 having multiple openings that can be in various configurations, the assembly 200 beneficially gives a user options for inserting differently-sized plant pots. In an additional embodiment, the plurality of openings may also have a rubber-like gasket that prevents the standard-sized plant pots from damaging inner portions of the opening and to prevent any debris or dirt from falling into the reservoir 318 (shown in FIG. 3). The cover 1100 may further have a resilient rubber insert 1102 at least partially within the one or more openings, which elastically deforms to create a snug fit between the cover 1100 and the plant pots. The insert 1102 may also prevent debris from falling into the water reservoir 318 (shown in FIG. 3). When the user desires to remove the standard-sized plant pot, the insert 1102 returns back to its static state, preventing any debris/dirt/mulch that may be placed on top of the cover 1100 from also falling into the water reservoir 318 and slowing any evaporation of the water within the reservoir 318. FIG. 11 also illustrates the rubber seal 618 that provides the coupling contact with one or more of the planter members 202, 204, 602. The cover 1100 may also have one or more handles 1104 that facilitate the user in uncoupling the cover 1100 from the planter member 202, 204, 602.

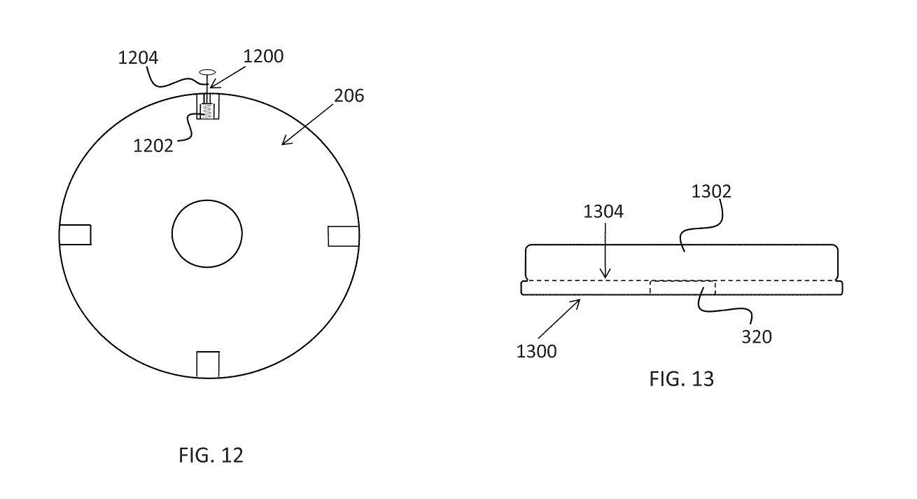

In one embodiment, a single cover 206 is sufficiently sized partially fit within the plurality of planter members. In other embodiments, the cover 206 is supported by the upper edge of one of the plurality of planter members. As the assembly 600 increases in height, so do the plurality of planter members and the corresponding upper openings. Referring to FIG. 12, one embodiment of the cover 206 is shown that accommodates the sequentially increasing upper openings. The cover 206 has at least one adjustable spring assembly 1200 that advantageously allows the one cover 206 to fit multiple planter members 202, 204, 602. The spring assembly consists of a spring 1202 with a spring constant “k” sufficient to allow a support pin 1204 to retract and expand a length determined by the user. Although FIG. 12 illustrates one spring assembly 1200, multiple spring assemblies 1200 may be utilized without, or in combination with, a rubber seal 618 (shown in FIGS. 6 & 11). In further embodiments, the assembly 600 may be provided with various covers 206 of sequentially increasing diameter, such that the user will select the appropriate cover 206 sized to fit on top of, or with, one of the plurality of planter members 202, 204, 602.

Looking at FIG. 13, one embodiment of the cover 1300 can be seen from an elevational side view. As shown, the cover 1300 has a side wall 1302 that extends upwardly from a top of surface 1304 of the cover 1300. The side wall 1302 may continuously extend around a circumference of the cover 1300 or may only extend upwardly from one or more portions of the top surface 1304. After a user inserts a standard-sized plant inside the at least one opening 320, the user may then fill the cover 1300 with additional soil/dirt to protect the plants and present a more aesthetically pleasing appearance. The cover 1300 resists the additional soil/dirt from entering and contaminating the reservoir 318 (shown in FIG. 3). The cover also prevents insects from entering the reservoir 318, which could cause contamination and/or breeding. The height of the side wall 1302 may be provided in various heights that do not substantially hinder the planter members 202, 204, 602 from operating as intended. In other embodiments, the cover 1300 may also have a dome that encloses the plants. The dome can be selectively retractable by the user. The assembly 200 may have a lighting assembly attached thereto that provides light to plants within the pot.

A stackable plant pot assembly has been disclosed that allows a user to store and maintain numerous plant pots with a single stackable unit that is adjustable to various heights and sizes. The assembly is very easily collapsible and effectively and efficiently stored. The assembly may be provided with a planter base and one or more intermediate planters that are stackable to create a watertight seal to provide a reservoir for the plants to feed from. The invention also discloses that a wick may be used to provide water from the reservoir to the plant pots, relieving the user of having to continually monitor and maintain those plants. A cover is provided with the assembly and used in connection with the planter members, the cover being capable of supporting plant pots of various sizes and configurations.

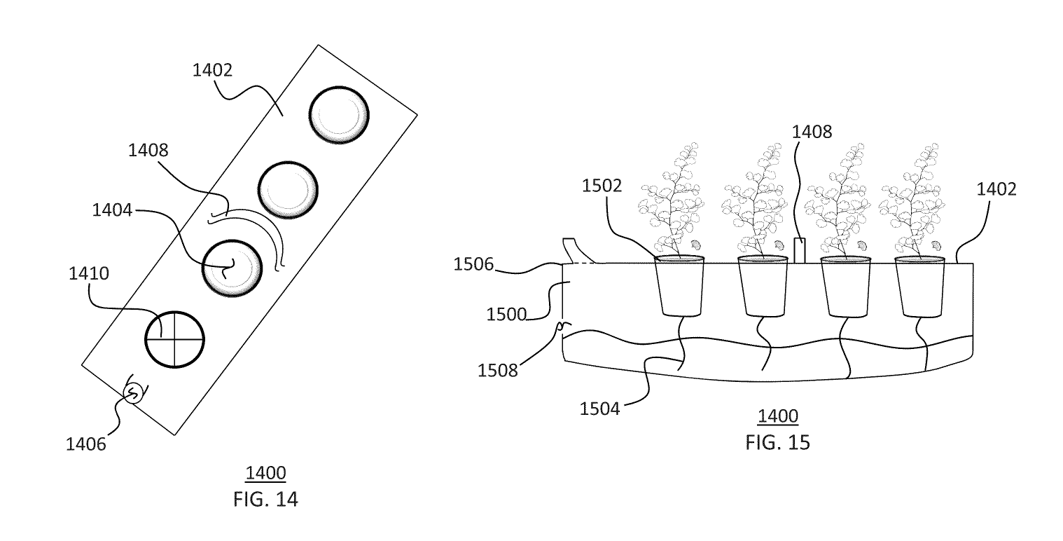

In accordance with alternative embodiments, FIGS. 14 and 15 illustrate a plant pot assembly 1400 that may also be used to water multiple plants from a single source. As shown in FIGS. 14 and 15, the assembly has a cover 1402 that is coupled to a base 1500. The cover 1402 may have a plurality of openings 1404 that are sized to fit a standard-sized plant pot 1502. In one embodiment, the cover 1402 may be removably-couplable to the base 1500 using one or more snap hooks. In other embodiments, press fits, snap fits, or cylindrical or spherical snap fits may be utilized. When in operation, water is filled into a reservoir, defined by the base 1500, through one or more openings 1406 in the cover 1402. Although FIGS. 14 and 15 illustrate exemplary shapes, dimensions, and locations of the components of the assembly 1400, a person skilled in the art can appreciate that those components may be configured, shaped, and dimensioned differently. After one or more plant pots 1502 are inserted within the openings 1404 a wick 1504 may extend from those pots 1502 toward the bottom of the base 1500. Should one or more openings 1404 not be desired to be used, one embodiment of the assembly 1400 provides a rubber insert 1410 within the opening 1404. This rubber insert 1410 prevents mulch or top soil, bugs, and other debris from entering the reservoir. The rubber insert 1410 may have a plurality of slits that allow the insert 1410 to deform to receive a plant pot 1502.

In one embodiment, the base 1500 may be inserted into the ground of an outside surface, e.g., a garden or the front yard of a house. In other embodiments, the base 1500 may be held up and supported by one or more legs or attached to the side of a structure, such as fence or house. This advantageously allows a user multiple locations to place the plant pots 1502, in addition to having an assembly 1400 that maximizes use of dirt/fertilizer and continually waters plants without constant human intervention. A transparent window may also be built into the base 1500 to monitor the water in the reservoir. Further, an upper edge 1506, or portion of the base 1500 in close proximity of the upper edge 1506, may have one or more apertures to prevent an overflow of water.

The cover may be removed through use of a handle 1408 thereby being easily transported, and hung or placed one or more hooks or other bases 1500. In one embodiment, multiple bases 1500 are utilized with multiple covers 1402 to create an extended plant pot water assembly. This assembly may one or more openings 1508 located on the base 1500 that allows each base 1402 to be in fluid communication with one another. As such, when the user desires to use one or more bases 1402 in combination with one another, a hose or other coupling mechanism with an opening may be inserted into each opening 1508 such that water can freely exchange between each adjacent base 1500 when it reaches a certain level in the reservoir. Should the user desire only base 1402 be utilized, then a plug or other similar mechanism may then be used to cap the opening 1508 where the water would have exchanged. The assembly 1400 further allows the cover 1500 to be removed, at which point the plurality of bases 1500 may then be stackable on top of one another. More specifically, a base 1500 would be inserted within the reservoir of another base 1500, thereby providing stackable plant watering assembly that is, again, easily storable when not desired to be used.

What is claimed is:

1. A stackable plant pot assembly comprising:
a planter base having:
a bottom surface;
an upper base edge that defines a base opening; and
a downwardly tapered side wall separating the upper base edge and the bottom surface;
a first intermediate planter:
having an upper edge defining an upper opening;
having a lower edge defining a lower opening;
having a downwardly tapered side wall separating the upper edge and the lower edge;
being sized to removably couple to the planter base and create a substantially watertight seal; and
being sized to stackably-receive the planter base within the upper opening of the first intermediate planter; and
a cover removably-couplable to the planter base and the first intermediate planter, the cover defining at least one opening sized to receive a standard-sized plant pot.

2. The stackable plant pot assembly according to claim 1, further comprising:
a wick that extends substantially from the standard-sized plant pot toward the bottom surface of the planter base.

3. The stackable plant pot assembly according to claim 1, wherein:
the upper opening of the first intermediate planter is sized to stackably-receive the planter base substantially within upper opening.

4. The stackable plant pot assembly according to claim 1, further comprising
a second intermediate planter:
having an upper edge defining an upper opening;
having a lower edge defining a lower opening;
having a downwardly tapered side wall separating the upper edge and the lower edge;
being sized to be removably-couplable to the first intermediate planter and create a substantially watertight seal; and
being sized to stackably-receive the planter base and the first intermediate planter within the second intermediate planter upper opening,
wherein the cover is removably-couplable to the planter base and the first and second intermediate planters, the cover defining at least one opening sized to receive a standard-sized plant pot.

5. The stackable plant pot assembly according to claim 4, wherein:
the second intermediate planter is further sized to be removably-coupable to the first intermediate planter and the planter base to create a substantially watertight seal.

6. The stackable plant pot assembly according to claim 4, wherein:
the upper opening of the second intermediate planter is sized to stackably-receive the planter base and the first intermediate planter substantially within upper opening.

7. The stackable plant pot assembly according to claim 1, wherein:
the cover is removably-couplable to an inside surface of the side wall of the planter base and the first intermediate planter.

8. The stackable plant pot assembly according to claim 1, wherein the cover further comprises:
a rubber seal located on an outer surface of the cover, wherein a portion of the rubber seal is removably-couplable to an inside surface of the side wall of the planter base and the first intermediate planter.

9. The stackable plant pot assembly according to claim 1, wherein the cover further comprises:
a plurality of openings sized to receive a standard-sized plant pot.

10. A stackable plant pot assembly comprising:
a planter base having:
a bottom surface;
an upper base edge that defines a base opening; and
a downwardly tapered side wall separating the upper base edge and bottom surface;
a plurality of intermediate planters:
each having an upper edge defining an upper opening;
each having a lower support edge defining a lower opening;
each having a downwardly tapered side wall separating the upper edge and the lower edge;
being sized to removably couple to at least one of the planter base and one of the plurality of intermediate planters to create a substantially watertight seal; and
having at least one upper opening being sized to stackably-receive the planter base and the plurality of intermediate planters within the at least one upper opening; and
a cover removably-couplable to the planter base and the plurality of intermediate planters, the cover defining at least one opening sized to receive a standard-sized plant pot.

11. The stackable plant pot assembly according to claim 10, wherein:
the at least one upper opening is sized to stackably-receive the planter base and the plurality of intermediate planters substantially within the at least one upper opening.

12. The stackable plant pot assembly according to claim 10, wherein:
the cover is removably-couplable to an inside surface of the side wall of the planter base and the plurality of intermediate planters.

13. The stackable plant pot assembly according to claim 10, wherein the cover further comprises:
a rubber seal located on an outer surface of the cover, wherein a portion of the rubber seal is removably-couplable to an inside surface of the side wall of the planter base and the plurality of intermediate planters.

14. The stackable plant pot assembly according to claim 10, wherein the cover further comprises:
a plurality of openings sized to receive a standard-sized plant pot.

15. The stackable plant pot assembly according to claim 10, further comprising:
a wick that extends substantially from the at least one opening in the cover toward the bottom surface of the planter base.

16. A stackable plant pot assembly comprising:
a plurality of planter members:
with one of the plurality of planter members having:
a bottom surface;
an upper base edge defining an upper base opening; and
a downwardly tapered side wall separating the upper base edge and the bottom surface;
with at least one of the plurality of planter members having:
an upper edge defining an upper opening;
a lower edge defining a lower opening;
a downwardly tapered side wall separating the upper edge and the lower edge and having an inner surface that defines an inner volume;
each being sized to removably couple to at least one of the plurality of planter members to form a substantially watertight seal; and
being removably-stackable at least partially within the inner volume of at least one of the plurality of planter members; and
a cover removably-couplable to at least one of the plurality of planter members, the cover defining at least one opening sized to receive a standard-sized plant pot.

17. The stackable plant pot assembly according to claim 16, wherein:
the plurality of planter members are removably-stackable substantially within the inner volume of at least one of the plurality of planter members.

18. The stackable plant pot assembly according to claim 16, wherein:
the cover is removably-couplable to an inside surface of the side wall of the plurality of planter members.

19. The stackable plant pot assembly according to claim 16, wherein the cover further comprises:
a plurality of openings sized to receive a standard-sized plant pot.

20. The stackable plant pot assembly according to claim 16, further comprising:
a wick that extends substantially from the at least one opening in the cover toward the bottom surface.
